(19) United States
(12) Patent Application Publication
(10) Pub. No.: US 2006/0072034 A1
(43) Pub. Date: Apr. 6, 2006

(54) Display device comprising a cathode ray tube

(75) Inventors: Janardhana Bhat, Singapore (SG); Chun Hsing Wu, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/542,905

(22) PCT Filed: Dec. 18, 2003
(86) PCT No.: PCT/IB03/06164

§ 371 Date: Jul. 20, 2005

(30) Foreign Application Priority Data
Jan. 24, 2003 (SG) 03/00020

(51) Int. Cl. H04N 5/68

(52) U.S. Cl. 348/379

(57) ABSTRACT

The display device has a cathode ray tube (T), which has an electron gun (G) for generating an electron beam and an outer conductive layer (AD). A video processing circuitry (VP) provides a video signal (Vo) having a black level (BLR, BLG, BLB) to a video amplifier (VA) for modulating the electron beam. The video processing circuitry (VP) has black level controlling circuitry (BL) for controlling the black level (BLR, BLG, BLB) of the video signal (Vo). A sensing circuit (S) senses a black current level of the electron beam corresponding to the black level of the video signal (Vo) and feeds back information about the black current level to the black level controlling circuitry (BL) for stabilizing the black current level. The sensing circuit (S) is coupled to a node (X) to which the outer conductive layer (AD) and one of the output terminals of a high-tension generator (H) are coupled.

The invention relates to a display device comprising:
a cathode ray tube having an electron gun for generating at least one electron beam and an outer conductive layer;
a video amplifier for modulating the at least one electron beam;
video processing circuitry for providing a video signal having a black level to the video amplifier, the video processing circuitry comprising black level controlling circuitry for controlling the black level of the video signal;
a high-tension generator having output terminals; and
a sensing circuit for sensing a black current level of the at least one electron beam corresponding to the black level of the video signal and for feeding back information about the black current level to the black level controlling circuitry for stabilizing the black current level.

An embodiment of such a device is known from US 2002/0130965. The known device has a sensing circuit having transistors, each transistor being connected to a respective one of the cathodes of the electron guns of the cathode ray tubes of a projection television system. The black level controlling circuitry inserts a level corresponding to a respective one of the black levels of each of the color components of the video signal in the color components of the video signal during one or more line periods within a vertical blanking period. These black levels are transferred to the cathodes via the video amplifiers. The resulting black current levels of the electron beams are sensed at the cathodes by the sensing circuit and fed back to the black level controlling circuitry. Based on the resulting black current levels the black level controlling circuitry adjusts the black levels of the video signal, so as to ensure that the black levels of the video signal correspond with the black current levels of the cathode ray tubes. In this way the described feedback loop stabilizes the black levels of the image on the screen of the cathode ray tubes. If, like mentioned in above example, more than one electron beam has to be controlled, the black level controlling circuitry generates sequentially, for example during successive lines, the black level for each of the electron beams to be controlled. In doing so, the sensing circuit may add the black current levels of each of the cathodes into one signal, which contains, for example; in successive lines the values of the black current levels of the individually sensed electron beans. In case of a color cathode ray tube three cathodes are present in one tube. These cathodes have to be operated usually at a voltage level of about 200V. As a result, at least 3 transistors capable of withstanding about 200V are required for sensing the electron beams. It is a drawback that these transistors are expensive and increase the capacitive load of the video amplifiers, thereby detoriating the frequency response of the video amplifiers.

It is an object of the invention to provide a display device of the kind described in the opening paragraph, which enables the presence of a relatively cheap sensing circuit.

The object is realized in that the sensing circuit is coupled to a node to which the outer conductive layer and one of the output terminals of the high-tension generator are coupled. As a result thereof, the black current level can be sensed at the anode side of the cathode ray tube instead of the cathode side. The voltage across the sensing circuit remains low in this case, for example in the range from 0V to 12V. So, the need for transistors in the sensing circuit that have to operate at a level of about 200V, is avoided, thereby allowing for a reduction of the cost of the sensing circuit. Moreover, the video response of the video amplifier improves, as there is no extra transistor, causing an additional capacitive load, required at the cathode for sensing the black current level. Finally, as there is no sensing circuit required between the video amplifiers and the cathode, the wire connection present between this cathode sensing circuit, which usually is located on a printed circuit board connected to the picture tube, and the video processing circuitry, which usually is present on a separate main printed circuit board, is avoided. The term “high-tension” denotes the voltage level at the anode of the cathode ray tube, which is in the order of magnitude of 25,000V.

It is advantageous if the sensing circuit is coupled between the node and a reference voltage source. By the presence of a reference voltage source, the voltage range at the output of the sensing circuit can be adapted to match the operating range of the black level controlling circuitry.

In an embodiment the electron gun (G) is adapted for generating three electron beams and the black level controlling circuitry is adapted for allowing the sensing circuit to sequentially sense the black current levels of each of the three beams. This embodiment may have the same sensing circuit as an embodiment in which only one electron beam has to be sensed. The respective black currents having the respective black current levels of each beam flow sequentially through the sensing circuit. The resulting sequential information is fed back to the black level controlling circuitry. As in this case three transistors having to operate at a level of about 200V for sensing the black current level at the cathodes can be avoided, a considerable cost saving is achievable.

It is advantageous if the sensing circuit comprises a current mirror circuit coupled between the node and the reference voltage source, an output of the current mirror circuit being coupled to the video processing circuitry. The mirror circuit ensures that the black current flowing through a main branch of the current mirror circuit is also flowing in a second branch of the circuit, which is coupled to the black level controlling circuitry. This allows that one end of the main branch is connected to a variable voltage. Such a variable voltage may be the result of a resistor connected between the reference voltage and the sensing circuit. In the case an electron gun is present for generating three beams, the total beam current of the three beams is flowing through this resistor, so the variable voltage is proportional to the total beam current. This variable voltage may be used in another feedback loop to control the average or peak value of the total beam current.

Japanese patent application 2002-099234 discloses a method of calibrating the black level, the cut-off level, by displaying sequentially the black level of each primary color on the full screen and measuring the beam current under these conditions. However, it is not disclosed how this detector is incorporated in a display device, neither is the circuitry of the detector disclosed.

These and other aspects of the display device of the invention will be further elucidated and described with reference to the drawings, in which:

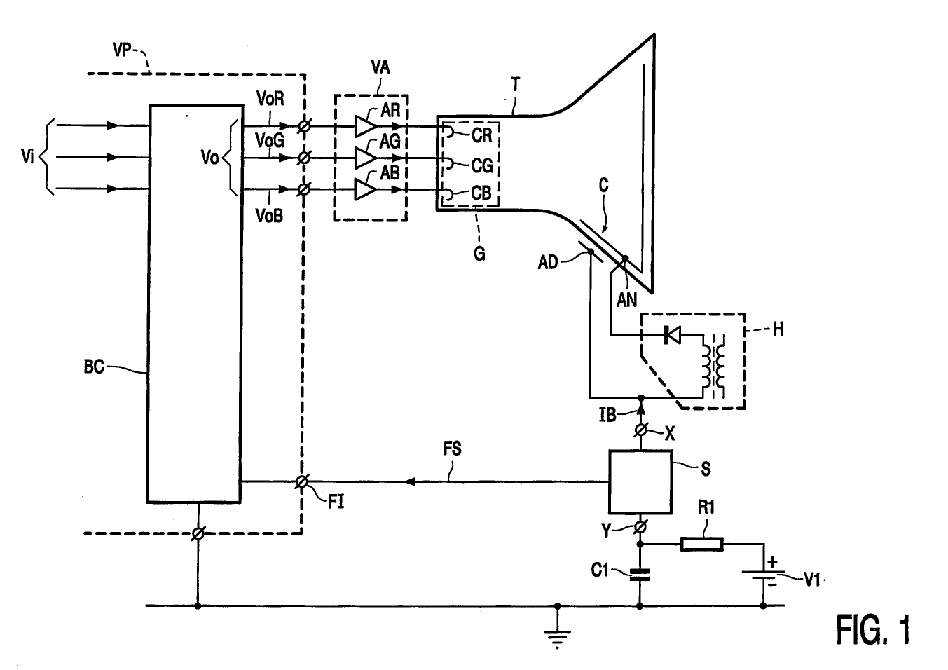

FIG. 1 shows a schematic diagram of an embodiment of a display device according to the invention;

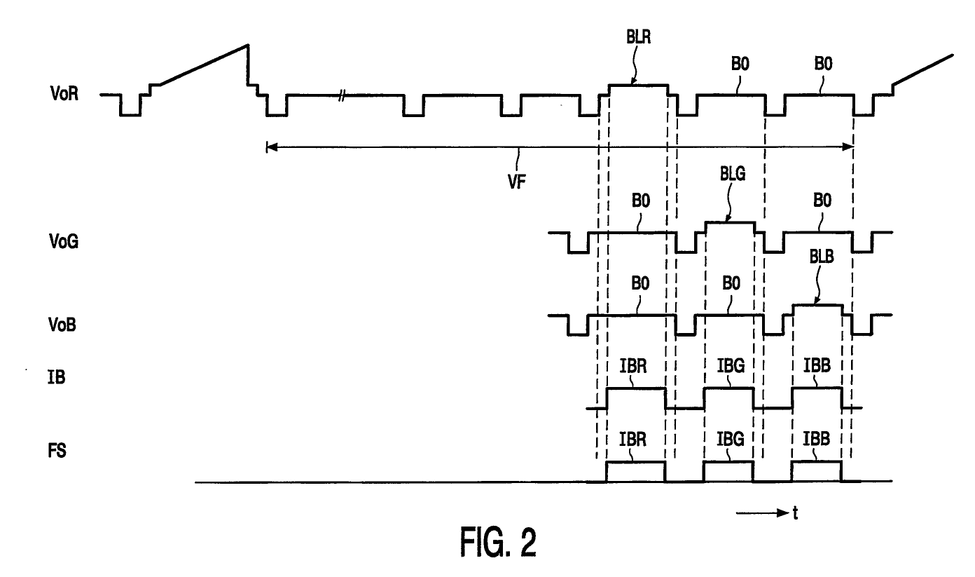

FIG. 2 shows waveforms of the video signal and feedback signal; and

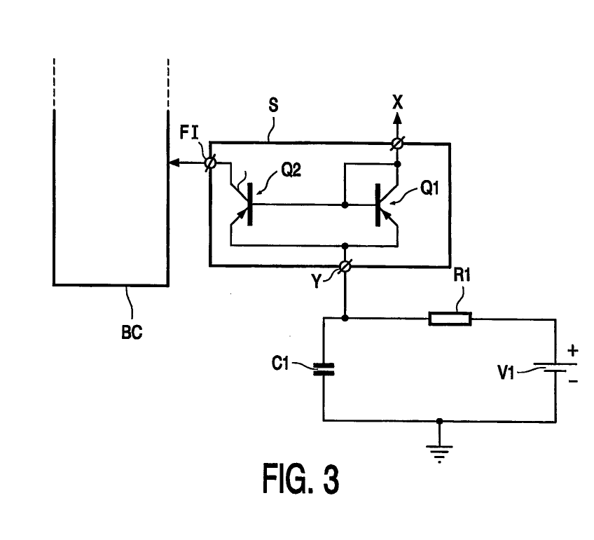

FIG. 3 shows an embodiment of the sensing circuit.

The same references in different FIGS. refer to the same signals or to the same elements performing the same function.

The display device shown in FIG. 1 has a cathode ray tube T, a video amplifier VA, video processing circuitry VP, a high-tension generator H, and a sensing circuit S. The tube T has an electron gun (G) for generating at least one electron beam. The cathode ray tube T may be a monochrome tube having an electron gun G with one cathode or a color tube having an electron gun G with three cathodes. In FIG. 1 a tube T is shown having a gun (G) comprising three cathodes CR, CG, CB for generating three electron beams corresponding to, for example, a red, green and blue color. The tube T further has an internal high tension capacitance C which is formed by a conductive layer at the inner side of the tube connected to an anode AN of the tube T and an outer conductive layer AD at the outside of the tube opposite to the inner conductive layer. The video amplifier VA comprises three amplifier stages AR, AG, AB which receive respective color components VoR, VoG, VoB of a video signal Vo. The respective amplifier stages AR, AG, AB of the video amplifier VA drive the respective cathodes CR, CG, CB to modulate the corresponding electron beams flowing from the respective cathodes CR, CG, CB to the anode AN. The video processing circuitry VP comprises black level controlling circuitry BL for controlling the black level of the video signal Vo. In the embodiment shown in FIG. 1 each of the color components VoR, VoG, VoB have a respective black level BLR, BLG, BLB controllable by the black level controlling circuitry BC. The video processing circuitry VP provides the video signal Vo to the video amplifier VA. The high tension generator H has two output terminals: one terminal is connected to the anode AN and the other terminal is connected to the outer conductive layer AD via node X. So, the output terminals of the high-tension generator H and the high-tension capacitance C are forming a parallel coupling. The sensing circuit S is connected in series with the parallel coupling at node X. The sensing circuit is also connected to a node Y. Node Y is connected to a reference voltage V1 via a resistor R1. Parallel to the series connection of resistor R1 and reference voltage V1 is connected a capacitor C1. The sensing circuit S has an output connected to a feedback input FI of the black level controlling circuitry BL.

As can be seen in FIG. 1 the three electron beams originating from the cathodes CR, CG, CB all reach the same anode AN of the tube T. So, in other words, at the anode side a beam current IB is flowing, being the sum of the three electron beam currents. This current flows from ground potential via node Y through the sensing circuit S and high tension capacitance C to the anode AN. Any discharging of the high tension capacitance C by the beam current IB is compensated by recharging via the high tension generator H. The resulting recharging current flows in the loop formed by the parallel coupling of the high tension generator H and the high tension capacitance C and does not flow into node X. So, as between node Y and X only the beam current IB is flowing, the sensing circuit S can be positioned between these nodes X and Y.

The black level controlling circuitry BL receives a video input signal Vi, which, in the example of a tube T having electron beams for generating a red, green and blue color, is composed of a red, green and blue color component. The DC level of each of the color components can be shifted by the black level controlling circuitry BL in dependence of a feedback signal FS received via a feedback input FI of the black level controlling circuitry BL. The purpose of the shifting is to ensure that the black level BLR, BLG, BLB of each of the color components VoR, VoG, VoB of the video signal Vo, present at the output of the black level controlling circuitry BL and applied to the cathode ray tube T via the video amplifier VA matches the respective black levels of the tube T. In this way the video signal Vo is rendered on the screen of the tube T with the correct black level. Moreover by matching the relative black levels of the color components VoR, VoG, VoB of the video signal Vo also a correct rendering of the colors is ensured.

Further the black level controlling circuitry BL inserts sequentially during a vertical flyback period VF, for example during a number of successive lines, a black level in each of the color components of the video-input signal Vi, resulting in waveforms as function of time t of the color components VoR, VoG, VoB of the video signal Vo as shown in FIG. 2. The inserted black levels of the respective color components VoR, VoG, VoB are indicated by BLR, BLG, and BLB respectively. During a time interval whereby in one of the respective color components VoR; VoG; VoB a black level BLR, BLG; BLB is inserted, the other color components VoR; VoG; VoB are having a blanking level BO below the black level BLR; BLG; BLB, so as to ensure that the corresponding electron beams are completely cut-off. So, the resulting beam current IB flowing through node X into the sensing circuit S comprises sequentially the black current levels IBR, IBG, IBB which may be detected sequentially by the sensing circuit S, resulting in a feedback signal FS of a similar shape as the beam current IB as shown in FIG. 2. The black level controlling circuitry BL uses the feedback signal FS to stabilize the black current levels IBR, IBG, IBB on a predetermined level by adapting the black level BLR, BLG, BLB of the respective color components VoR, VoG, VoB of the video signal Vo until the predetermined level is obtained for each of the color components VoR, VoG, VoB.

As it is desirable to detect also an average beam current value and/or a peak beam current value, the resistor R1 is present between node Y and the reference voltage V1 as shown in FIG. 1. As a result the voltage on node Y may fluctuate dependent on the beam current. This voltage may be used in another feedback loop to limit the average and/or peak beam current. The time constant applied for the averaging is determined by the RC-time of resistor R1 and capacitor C1.

As the sensing circuit S is connected via node Y to a fluctuating voltage, a special circuit configuration is required for the sensing circuit S to sense the beam current IB. An embodiment of a suitable sensing circuit S is shown in FIG. 3. A first transistor Q1 has first main terminals, being an emitter and a collector connected to Node Y and Node X, respectively. The first transistor Q1 further has a first control terminal, being the base, connected to Node X. A second transistor Q2 has second main terminals, being an emitter and a collector connected to Node Y and to the feedback input FI, respectively. The second transistor Q2 further has a second control terminal, being the base, connected to the first control terminal. The described configuration of the first Q1 and second transistor Q2 is a current mirror. The beam current IB flowing through the main current path via the collector and emitter of the first transistor Q1 is “mirrored” in the second transistor Q2. So, through the second transistor Q2 a current flows from its emitter to its collector, being the output of the current mirror circuit, towards the feedback input FI, which is equal to the beam current IB.

It should be noted that the above-mentioned embodiments illustrate rather than limit the invention, and that those skilled in the art will be able to design many alternative embodiments without departing from the scope of the appended claims. For example, the invention may also be applied to a projection television system applying a separate monochrome cathode ray tube for each color, whereby the high tension capacitance C of each of the tubes are coupled in parallel to a common high tension generator H.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display device comprising:
a cathode ray tube (T) having an electron gun (G) for generating at least one electron beam, and an outer conductive layer (AD);
a video amplifier (VA) for modulating the at least one electron beam;
video processing circuitry (VP) for providing a video signal (Vo) having a black level (BLR, BLG, BLB) to the video amplifier (VA) , the video processing circuitry (VP) comprising black level controlling circuitry (BL) for controlling the black level (BLR. BLG, BLB) of the video signal (Vo);
a high-tension generator (H) having output terminals;
and a sensing circuit (S) for sensing a black current level (IBR, IBG, IBB) of the at least one electron beam corresponding to the black level (BLR, BLG, BLB) of the video signal (Vo) and for feeding back information about the black current level (IBR, IBG, 1BB) to the black level controlling circuitry (BL) for stabilizing the black current level (IBR, IBG, IBB),
the sensing circuit (S) being coupled to a node (X) to which the outer conductive layer (AD) and one of the output terminals of the high-tension generator (H) are coupled.

2. A display device as claimed in claim 1, wherein the sensing circuit (S) is coupled between the node (X) and a reference voltage source (V1).

3. A display device as claimed in claim 1, wherein the electron gun (G) is adapted for generating three electron beams; and the black level controlling circuitry (BL) is adapted for allowing the sensing circuit (S) to sequentially sense the black current levels (IBR, IBG, IBB) of each of the three beams.

4. A display device as claimed in claim 1, wherein the sensing circuit (S) comprises a current mirror circuit coupled between the node (X) and the reference voltage source (V1), an output of the current mirror circuit being coupled to the video processing circuitry (VP).

5. A display device as claimed in claim 4, wherein the current mirror circuit comprises:
a first transistor (Q1) having a pair of first main terminals and a first control terminal, the first main terminals being coupled between the node (X) and the reference voltage source (V1), the first control terminal being coupled to the node (X); and
a second transistor (Q2) having a pair of second main terminals and a second control terminal, the second control terminal being coupled to the first control terminal, one of the second main terminals being coupled to the reference voltage. source (V1) and the other of the second main terminals being coupled to the video processing circuitry (VP).
